(19) United States
(12) Patent Application Publication
(10) Pub. No.: US 2016/0165806 A1
(43) Pub. Date: Jun. 16, 2016

(54) CONTAINER WITH TAG RETAINING MEMBER

(71) Applicant: J.M. McConkey & Co., Inc., Sumner, WA (US)

(72) Inventors: Steve Ying, Sumner, WA (US); Derek Moeller, Sumner, WA (US); Doug Shelton, Sumner, WA (US)

(21) Appl. No.: 14/572,583

(22) Filed: Dec. 16, 2014

(51) Int. Cl. A01G 9/00; F16B 2/22; A01G 9/02; G09F 3/00

(52) U.S. Cl. CPC A01G 9/006; G09F 3/00; F16B 2/22; A01G 9/02; G09F 2023/0025

(57) ABSTRACT

Methods and apparatus for retaining an informational tag to a container are provided. In some embodiments of the disclosure, a container is provided with a retaining member on a rim thereof. The retaining member can have in inlet opening, with an inlet channel having inwardly tapering walls that terminate at an outlet aperture. The outlet aperture can have a zigzagging configuration for compressing the tag.

### BACKGROUND

1. Technical Field The present disclosure relates to containers for plants, and in particular, retaining members for informational tags on planting pots.

2. Description of Related Art

Planting pots are often provided with apertures, such as, for example, slots, formed on a portion of the pots, for use in retaining informational tags or labels. The informational tags or labels can be constructed of plastic, or other flexible material with at least some elastic deformation characteristics, to exert tension against a perimeter of the apertures within which the tag has been compressed. As such, the apertures can be designed to require that a portion of the tag is crimped or otherwise bent, to be placed into the aperture, after which, the elastic tendency of the tag places it under tension to bias the tag against the perimeter of the aperture, to retain the tag. In this manner, information on the tag can be easily affixed to a planting pot, and/or, removed from the planting pot. Many such conventional tags and aperture assemblies are inconvenient, and unreliable. Among other things, the tags may be difficult to insert, and may only loosely retain the tags.

### BRIEF SUMMARY

Some embodiments of the present disclosure comprise a container having a retaining member for retaining an informational tag to the container. The retaining member can include an aperture and an inlet channel having an inlet opening opposite the aperture. The inlet channel can have an inwardly tapering sidewall that tapers inward from the inlet opening to join and terminate at a perimeter of the aperture. In some embodiments, the aperture is a non-linear elongated slot, and can be formed in a zigzagging configuration.

Some embodiments of the present disclosure comprise a method of retaining a tag on a container. The method can include inserting a tag into an inlet opening of a retaining member and pushing the tag through an inlet channel having an inwardly tapering sidewall, until the tag extends through an outlet aperture. The tag can be compressed by compressing lateral edges of the tag toward one another to extend the tag through the outlet aperture. Furthermore, the tag can be compressed by imparting two or more bends on the tag, with at least two of the bends being toward opposite directions relative to a planar surface of the tag.

### BRIEF DESCRIPTION OF THE DRAWINGS

FIG. 1 is a bottom perspective view of a plant container for some embodiments of the present disclosure, showing a tag placed within a retaining member formed on the container.

FIG. 1B is a front elevation view of an example tag, for use in some embodiments of the present disclosure.

FIG. 2 is a bottom perspective view of the plant container of FIG. 1, with the tag removed from the retaining member.

FIG. 2B is an enlarged perspective view of the retaining member for the plant container of FIG. 2.

FIG. 3 is a top plan view of the plant container of FIG. 2.

FIG. 3B is an enlarged top plan view of the aperture of the retaining member, with a tag retained within the aperture.

### DETAILED DESCRIPTION

In the following description, certain specific details are set forth in order to provide a thorough understanding of various embodiments of this disclosure. However, upon reviewing this disclosure one skilled in the art will understand that the invention may be practiced without many of these details. In other instances, well-known or widely available structures associated with plant pots, or informational tags used on plant pots, have not been described in detail to avoid unnecessarily obscuring the descriptions of the embodiments of the present disclosure.

Various embodiments of the present disclosure are described herein for purposes of illustration, in the context of use with plant pots. However, as those skilled in the art will appreciate upon reviewing this disclosure, use with other types of containers may also be suitable.

In the present description, where used, the terms “about” and “consisting essentially of” mean ±20% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives, unless expressly stated otherwise. As used herein, the terms “include” and “comprise” are used synonymously, and those terms and variants thereof are intended to be construed in a non-limiting, open sense.

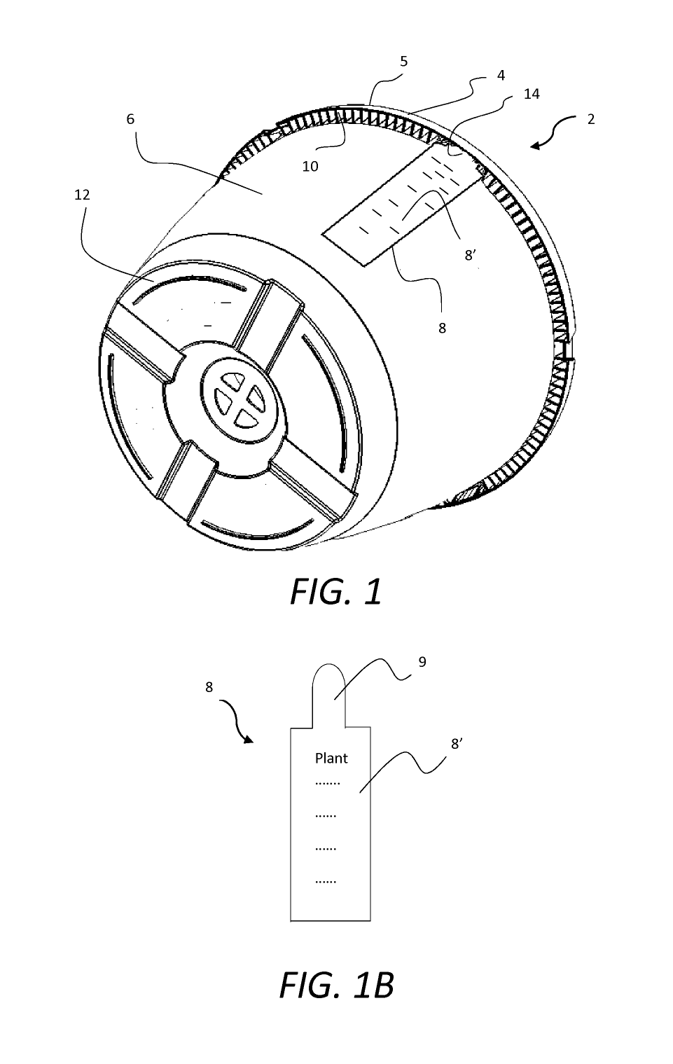

As shown in FIGS. 1-3B, some embodiments of the present disclosure comprise a container 2 for holding planting soil and one or more plants. The container 2 can comprising a bottom wall 12, a vertical sidewall 6 extending upward from the bottom wall, and a top rim 4, positioned at a top edge region of the vertical sidewall 6. The rim 4 can extend laterally outward from the vertical sidewall 16, surrounding the entire circumference of the top edge region of the vertical sidewall 16, and can be reinforced by spaced apart support ribs 10, the spaced apart support ribs 10 extending radially outward from the vertical sidewall 6. In some embodiments, such as that illustrated, the rim 4 is annular in shape, and a vertical sidewall 6 is comprised of annular horizontal cross sections.

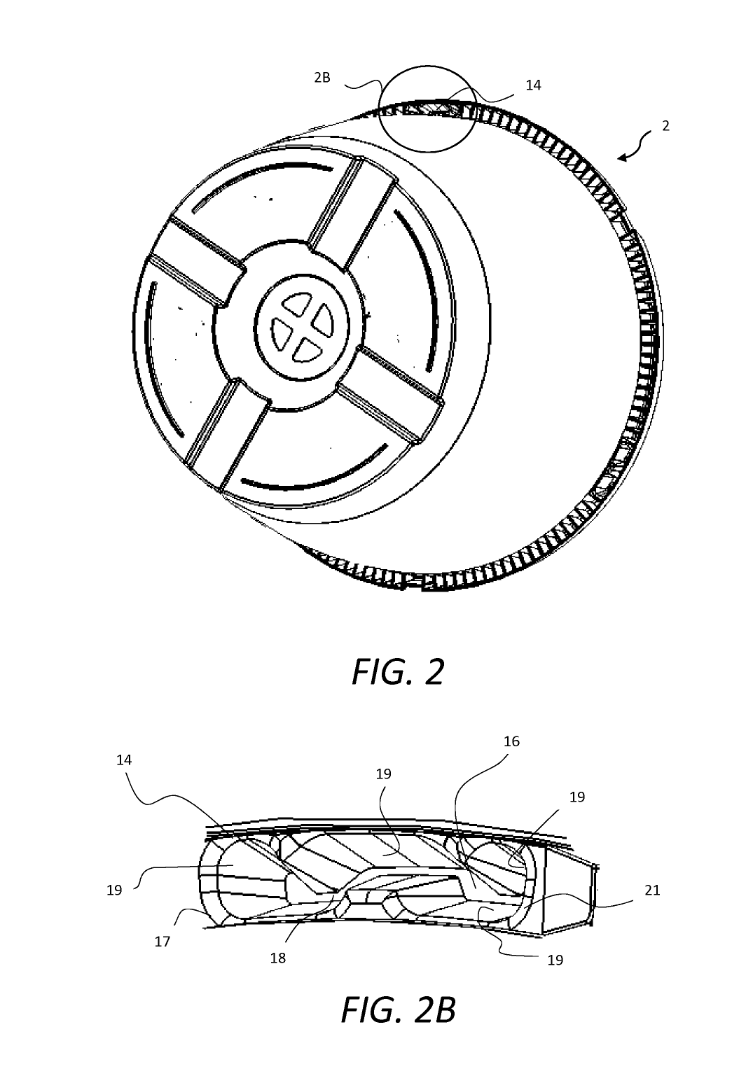

Referring to FIGS. 1-2B, in some embodiments, a retaining member 14 is formed on the rim 4 of the container 2, accessible from a downward facing portion of the rim 4.

As best seen in FIGS. 1 and 1B, the retaining member 14 can be used to retain an informational tag 8, having text and/or graphical designs, printed thereon, by inserting a retaining strip 9 of the tag 8, into an aperture 16 of the retaining member 14. In some embodiments, the retaining strip 9 must be deformed to be placed within the aperture 16. The tag 8, including its retaining strip 9, or only the retaining strip 9, can be a sheet like material, comprised of a plastic, or any other material having at least some elastic deformation tendencies sufficient to allow the retaining strip 9 to exert biasing force against the inside wall of the aperture when the retaining strip 9 is crimped and pushed through the aperture 16, to place the retaining strip 9 under tension against inside walls of the aperture, to thereby retain the tag 8.

As shown in FIGS. 1 & 1B, in some embodiments, the retaining strip 9 extends upward from a top portion of the tag 8, with respect to the orientation of textual information, so that the retaining strip 9 can be inserted in an upwardly direction, from below the rim 4, into the retaining member 14, with a main body portion 8′ of the tag 8 hanging below the retaining member 14.

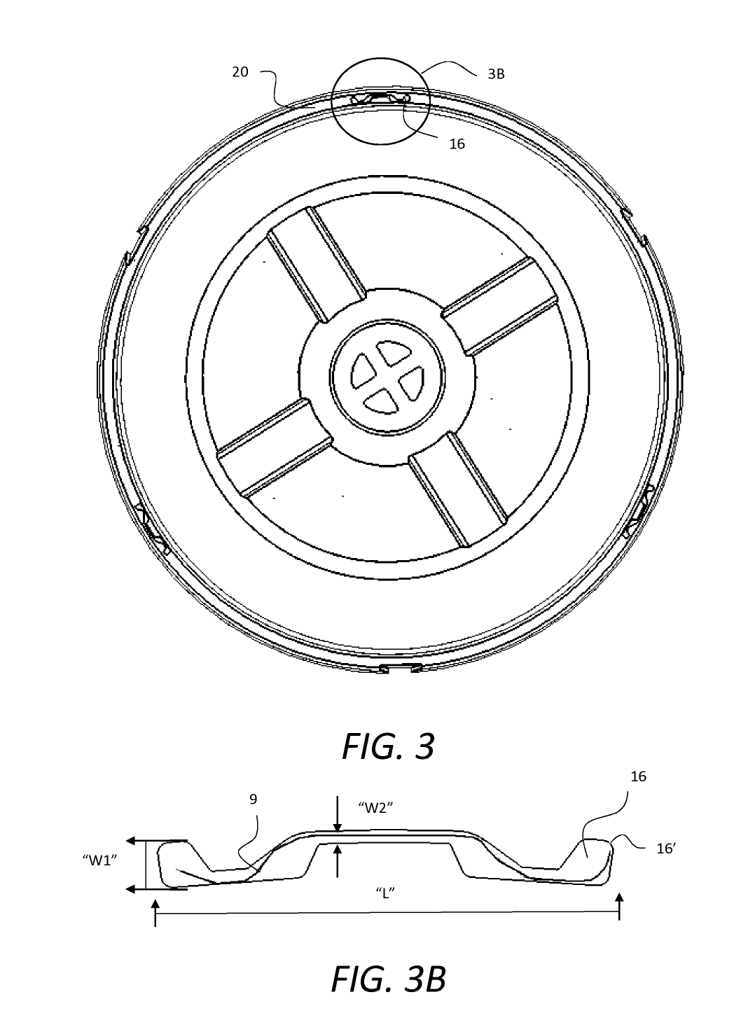

As best seen in FIGS. 2-3B, the retaining member 14 can comprise a non-linear, elongated aperture 16 (or slot like opening), opening on an upward facing wall 20 of the rim 4, and an inlet channel 18 leading to the aperture 16 from below the aperture 16. The inlet channel 18 can have an inlet opening 17 on a downward facing side of the rim 4, with a laterally inwardly tapering sidewall 19 that extends upward toward the aperture 16, with one or more portions of the inwardly tapering sidewall 19, tapering laterally inward toward a perimeter of the aperture 16 and terminating at the aperture 16.

As will be appreciated by those skilled in the art after reviewing the present disclosure, a user may insert a portion of a tag (e.g., a retainer strip 9) upward through the inlet opening 17 of the retaining member 14, to be guided by the inwardly tapering sidewall 19, through the aperture 16. As the tag is pushed upward, the inwardly tapering sidewall 19 can cause the edges of the tag to be compressed laterally toward one another, to crimp the tag gradually to conform to a contour that can pass through the aperture 16, before being pushed through the aperture 16, as best seen in FIG. 3B (showing a top plan view of the aperture with retaining strip 9 pushed through the aperture).

The aperture 16 itself can be defined by a perimeter 16′ formed at the top wall of the rim 4, with the aperture 16 zigzagging (or otherwise alternating in direction) across a face thereof, as best seen in FIG. 3B. When the tag (or portion thereof, such as the retaining strip 9), is pushed through the aperture 17 in crimped or compressed form, and conforming to the zigzag perimeter shape of the aperture 17, the elastic characteristics of the tag cause it to exert tension on the inside perimeter 16′ of the aperture 17, to removably retain the tag in the retaining member 14.

Referring to FIG. 3B, in some embodiments, a length “L” of the elongated aperture is about 1.07 inches. In other embodiments, the length is about 1.07 centimeters. In other embodiments, the length is less than or greater than 1.07 inches, or 1.07 centimeters.

Length “L” is defined to represent the furthest distance between two perimeter points of the elongated aperture 16. In some embodiments, the width W1, between two perimeter points of the elongated aperture is about 0.11 inches. In other embodiments, W1 is greater than, or less than 0.11 inches. In some embodiments, the width W2, between two perimeter points of the elongated aperture is about 0.03 inches. In other embodiments, W2 is greater than, or less than 0.03 inches. In other embodiments, the dimensions indicated above as inches, are instead, centimeters.

In some embodiments, the inwardly tapering sidewall extends vertically a distance that is equal to about one third of a length “L” of the elongated aperture 16. In some embodiments, the inwardly tapering sidewall extends vertically a distance that is equal to about half of a length “L” of the elongated aperture 16. In some embodiments, the inwardly tapering sidewall extends vertically a distance that is equal to about ¾ of a length “L” of the elongated aperture 16. In other embodiments, the inwardly tapering sidewall extends vertically a distance that is greater than one third, one half, or ¾ of a length “L” of the elongated aperture. In other embodiments, the inwardly tapering sidewall extends vertically a distance that is less than one third, one half, or ¾ of a length “L” of the elongated aperture.

After reviewing the present disclosure, an individual of ordinary skill in the art will immediately appreciate that some details and features can be added, removed and/or changed without deviating from the spirit of the invention. Reference throughout this specification to “one embodiment,” “an embodiment,” or “some embodiments,” means that a particular feature, structure or characteristic described in connection with the embodiment(s) is included in at least one or some embodiment(s), but not necessarily all embodiments, such that the references do not necessarily refer to the same embodiment (s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A container comprising:
at least one sidewall;
at least one bottom wall; and
a retaining member for retaining an informational tag to the container, the retaining member comprising:
an aperture; and
an inlet channel having an inlet opening opposite the aperture, the inlet channel having an inwardly tapering sidewall that tapers inward from the inlet opening to join and terminate at a perimeter of the aperture.

2. The container of claim 1 wherein the aperture is a non-linear elongated slot.

3. The container of claim 2 wherein the slot has a zigzagging configuration.

4. The container of claim 3 wherein the zigzagging configuration of the slot includes at least one longitudinally extending portion that extends in a linear fashion for a longer distance than any other portion of the slot.

5. The container of claim 1 wherein the retaining member is disposed on a rim of the container, and wherein the inlet opening faces downward with respect to the container.

6. The container of claim 1 wherein the inwardly tapering sidewall extends vertically a distance that is at least one third of a width of the aperture, the width of the aperture being measured between two points on the aperture that are spaced furthest apart on the perimeter of the aperture.

7. The container of claim 1 wherein the inwardly tapering sidewall extends vertically a distance that is at least one half of a width of the aperture, the width of the aperture being measured between two points on the aperture that are spaced furthest apart on the perimeter of the aperture.

8. The container of claim 1 wherein an entire terminating end of the inwardly tapering sidewall is joined to a perimeter of the aperture.

9. The container of claim 1 further comprising a beveled edge disposed immediately inside of the inlet opening of the retaining member, between in the inlet opening and the inwardly tapered sidewall.

10. A retaining member for a tag comprising:
a first end opening connected to an inlet channel having an inwardly tapering sidewall; and
a second end opening at which the inwardly tapering sidewall terminates, the second end opening having smaller maximum width, than a maximum width of the first end opening, and wherein the second end opening has a perimeter comprising a zigzagging configuration.

11. The retaining member of claim 10 further comprising a beveled edge connecting the first end opening to the inwardly tapering sidewall.

12. A method of retaining a tag on a container comprising:
inserting a tag into an inlet opening of a retaining member; and
pushing the tag through an inlet channel having an inwardly tapering sidewall, until the tag extends through an outlet aperture.

13. The method of claim 12 further comprising compressing lateral edges of the tag toward one another to extend the tag through the outlet aperture.

14. The method of claim 13 wherein compressing the tag further comprises imparting two or more bends on the tag, with at least two of the bends being toward opposite directions relative to a planar surface of the tag.

15. The method of claim 12 wherein the pushing the tag through the inlet channel comprises pushing the tag upward relative to a resting position of the container.
